(19) United States
(12) Patent Application Publication
(10) Pub. No.: US 2006/0228604 A1
(43) Pub. Date: Oct. 12, 2006

(54) Membrane, membrane electrode assembly having same, and method for making the membrane

(75) Inventor: Chuan-De Huang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/399,802

(22) Filed: Apr. 7, 2006

(30) Foreign Application Priority Data
Apr. 8, 2005 (CN) 200510034108.3

(51) Int. Cl. H01M 8/10; H01M 4/86; H01M 4/96; H01M 4/90; H01M 4/92; B05D 5/12; B32B 15/08

(52) U.S. Cl. 429/30; 428/461; 427/115; 427/123; 427/125; 429/44

(57) ABSTRACT

The present invention relates to a membrane (100) for fuel cells, a method for making the same and a membrane electrode assembly. The membrane (100) includes a polymer base (110) and a metal layer (120) formed on the polymer base. The method for making the membrane includes the steps of providing a polymer base and forming a metal layer on the polymer base. The present invention also provides a membrane-electrode assembly (1000) using the above-described membrane.

### BACKGROUND

1. Field of the Invention

The invention relates generally to membranes for fuel cells and, more particularly, to a membrane for a fuel cell, for example, a direct methanol fuel cell (DMFC), a method for making the same and a membrane-electrode assembly having the same.

2. Discussion of Related Art

Fuel cells are electrochemical devices that convert chemical energy directly into electrical energy with no intermediary stage, and thus do so with high efficiency. Fuel cells function on the principle of reverse electrolysis, that is, fuel (such as hydrogen) and oxidant (such as oxygen) are respectively oxidized and reduced at an anode electrode and a cathode electrode, yielding only water and heat as byproducts while converting chemical energy into electricity. According to the electrolyte used, fuel cells can be classified into general groups including phosphoric acid fuel cells, molten carbonate fuel cells, solid oxide fuel cells, proton exchange membrane fuel cells (PEMFCs), and alkaline fuel cells. The PEMFCs perform well at low working temperatures (down to about 80 degrees Celsius) have high efficiency, long operation life, high specific power density and high specific energy density.

Theoretically, hydrogen gas and oxygen gas are ideal fuel and oxidant for PEMFCs. However, pure hydrogen gas is unsafe because of its high chemical reactivity and difficulty in storage. Therefore, direct methanol fuel cells (DMFCs) were developed to meet these problems. DMFCs utilize methanol as fuel, thus rendering the fuel cell safely as methanol does not spontaneously react with oxygen at room temperature.

Conventional DMFCs suffer from a problem which will be familiar to those skilled in the art: cross-over of methanol from the anode to the cathode through electrolyte membranes, causing significant loss in efficiency. Cross-over occurs because of the high solubility of methanol in the membrane. In order to minimize cross-over, and thereby minimize the loss of efficiency, the concentration of methanol in the fuel feed stream should be kept low by dilution with water. However, dilution of the methanol introduces other disadvantages: (1) fuel cell construction becomes more complicated and costly because of additional structures and processes needed to store and manage the water; and (2) the energy per unit volume of the fuel cell, which is a critical factor in terms of the fuel cell's potential commercial applications, is reduced.

What is needed, therefore, is a electrolyte membrane which can lower or eliminate cross-over of methanol from an anode to a cathode, while allowing protons to pass through.

### SUMMARY

In one aspect, of the present invention, a membrane for fuel cells is provided. The membrane includes a polymer base and a metal layer formed on the polymer base. The polymer base is comprised of a material selected from the group consisting of polyethylene, polypropylene, polysulfone, polyimide, polyvinylidenefluoride, polyurethane, polystyrene, polyvinylchloride, cellulose, nylon, a copolymer of vinylidenefluoride and hexafluoropropylene, a copolymer of vinylidenefluoride and trifluoroethylene, a copolymer of vinylidenefluoride and tetrafluoroethylene, acrylate based polymer, polyacrylonitrile, polyvinylacetate, polyethyleneoxide, and polypropyleneoxide. The metal layer is comprised of a material selected from the group consisting of nickel, palladium, platinum and gold.

In another aspect of the present invention, a method for making the above-described membrane is provided. The method includes the steps of providing a polymer base, forming a first metallic layer on the polymer base, and forming a second metallic layer on the first metallic layer. The first metallic layer is made by a sputtering method. The second metallic layer is made by an electroless plating method.

In still another aspect of the present invention, a membrane-electrode assembly is provided. The membrane electrode assembly includes an anode, a cathode and the above-described membrane.

Advantages and novel features of the present invention will become more apparent from the following detailed description of preferred embodiments when taken in conjunction with the accompanying drawings.

### BRIEF DESCRIPTION OF THE DRAWINGS

Many aspects of the present membrane, membrane electrode assembly, and method for making the membrane can be better understood with reference to the following drawings. The components in the drawings are not necessarily drawn to scale, the emphasis instead being placed upon clearly illustrating the principles of the present membrane, method for making the same and membrane electrode assembly.

FIG. 1 is a schematic, cross-sectional view of a membrane in accordance with a preferred embodiment; and

FIG. 2 is a schematic, cross-sectional view of a membrane-electrode assembly using the membrane of FIG. 1.

Corresponding reference characters indicate corresponding parts throughout the several views. The exemplifications set out herein illustrate at least one preferred embodiment of the present invention, in one form, and such exemplifications are not to be construed as limiting the scope of the invention in any manner.

### DETAILED DESCRIPTION OF PREFERRED EMBODIMENTS

Reference will now be made to the drawings to describe embodiments of the present membrane, membrane electrode assembly having the same, and method for making the membrane, in detail.

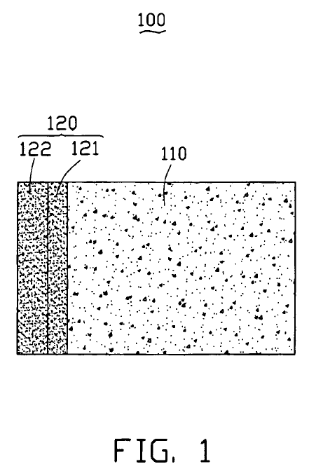

Referring to FIG. 1, a membrane 100 according to an exemplary embodiment is shown. The membrane 100 includes a polymer base 110 and a metal layer 120. The polymer base 110 functions as an electrolyte. The polymer base 110 is comprised of a material selected from the group consisting of polyethylene, polypropylene, polysulfone, polyimide, polyvinylidenefluoride, polyurethane, polystyrene, polyvinylchloride, cellulose, nylon, a copolymer of vinylidenefluoride and hexafluoropropylene, a copolymer of vinylidenefluoride and trifluoroethylene, a copolymer of vinylidenefluoride and tetrafluoroethylene, acrylate based polymer, polyacrylonitrile, polyvinylacetate, polyethyleneoxide, and polypropyleneoxide. The polymer base 110 is also commercially available from Nafion® polymer membranes. The Nafion polymer membrane is a kind of perfluorinated ionomer membrane, taking the shape of a transparent film with a thickness of about 150 micrometers. The Nafion polymer membrane has an equivalent weight of about 1100, and when it is hydrated it has a proton conductivity of 10⁻² S/cm or higher.

The metal layer 120 is made of a metal selected from the group consisting of nickel, palladium, platinum and gold. The relatively un-reactive material, platinum, is also used as catalyst particles for catalyzing electrochemical reaction. The metal layer 120 can prevent fuels, such as methanol, from crossing-over the polymer base 110. Thickness of the metal layer 120 can be adjusted according to the kind of material being blocked.

A method for making the above-described membrane 100 includes the steps of providing a polymer base, forming a first metallic layer on the polymer base, and forming a second metallic layer on the first metallic layer.

Referring to FIG. 1, a polymer base 110 is provided. A first metallic layer 121 is formed on the polymer base 110 by a sputtering method. The first metallic layer 121 is comprised of a material selected from the group consisting of nickel, palladium, platinum and gold. In the illustrated embodiment, the first metal layer 121 is formed by a plasma sputtering deposition method. The polymer base 110 is initially placed in a plasma sputtering apparatus (not shown). The working pressure of the plasma sputtering apparatus is configured to be about 0.05 torr. The working temperature of the plasma sputtering apparatus is configured to be about 150° C. Reactant gases are introduced in a reaction chamber of the plasma sputtering apparatus so as to form plasma. Using the plasma to bombard a target of nickel, palladium, platinum and gold, the sputtered atoms of the target will be excited and are deposited on a surface of the polymer base 110 to form a thin first metallic layer 121.

On the first metallic layer 121, a second metallic layer 122 is formed by an electroless plating method for enhancing the ability of preventing fuels, such as methanol, crossing over the membrane 110. The second metallic layer 122 is formed in a plating solution containing metal ions and a reducing agent. A catalyst is utilized to catalyze the redox reaction, thereby the metal ions are reduced from their ionic state into a solid metal state. The reducing agent is generally sodium borohydride or hypophosphite. The plating solution is an acid solution with a PH value in the range from about 4.2 to about 4.8. The plating solution may be an alkaline solution. The thickness of the second metallic layer 122 can be adjusted by controlling the time period of the electroless plating process.

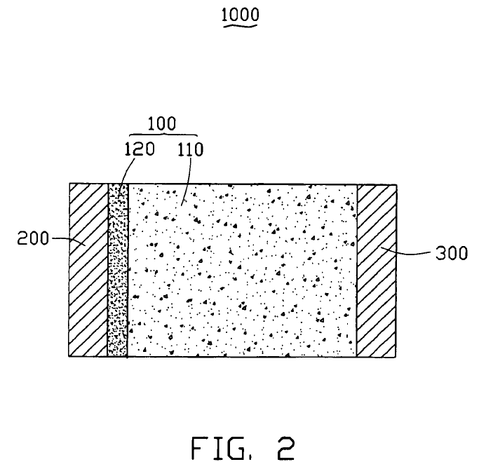

Referring to FIG. 2, a membrane-electrode assembly 1000 according to an exemplary embodiment is shown. The membrane electrode assembly 1000 includes an anode 200, a cathode 300 and an above-described membrane 100.

The anode 200 and the cathode 300 are electrically conductive. Materials of the anode 200 and the cathode 300 are selected from graphite, carbon composites and conductive metals. Catalysts, such as platinum and ruthenium, are coated on the anode 200 and cathode 300 uniformly for inducing electrochemical reaction. The catalytic anode 200 and cathode 300 are intimately bonded to each side of the above-described membrane 100 to form the membrane-electrode assembly 1000.

The membrane-electrode assembly 1000 can be used for direct methanol fuel cells (DMFC), polymer electrolyte fuel cells (PEFC) or proton exchange membrane fuel cells (PEMFC). The fuel can be a liquid or a vapor methanol/water mixture and the oxidant can be air or oxygen. Protons are produced by oxidation of methanol at the anode 200 and pass through the membrane 100 from the anode 200 to the cathode 300. Electrons produced at the anode 200 in the oxidation reaction flow in the external circuit to the cathode 300, driven by the potential difference between the anode 200 and the cathode 300,thus producing a current capable of performing useful work.

The electrochemical reactions occurring in a direct methanol fuel cell which contains the membrane electrode assembly 1000 are:
Anode CH.sub.3OH+H.sub.2O.fwdarw.CO.sub.2+6H.sup.++6e.sup.− (1)
Cathode3/2O.sub.2+6H.sup.++6e.sup.−.fwdarw.3H.sub.2O (2)
Overall CH.sub.3OH+3/2O.sub.2.fwdarw.CO.sub.2+2H.sub.2O (3)

Compared with conventional systems, the present invention uses a metal layer to prevent fuels such as methanol from crossing over an electrolyte membrane, thus minimizing or eliminating energy efficiency loss.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A membrane for fuel cells, comprising:
a polymer base; and
a metal layer formed on the polymer base, the metal layer being comprised of a material selected from the group consisting of nickel, palladium, platinum and gold.

2. The membrane as claimed in claim 1, wherein the polymer base is comprised of a material selected from the group consisting of polyethylene, polypropylene, polysulfone, polyimide, polyvinylidenefluoride, polyurethane, polystyrene, polyvinylchloride, cellulose, nylon, a copolymer of vinylidenefluoride and hexafluoropropylene, a copolymer of vinylidenefluoride and trifluoroethylene, a copolymer of vinylidenefluoride and tetrafluoroethylene, acrylate based polymer, polyacrylonitrile, polyvinylacetate, polyethyleneoxide, and polypropyleneoxide.

3. The membrane as claimed in claim 1, wherein the metal layer is formed on the polymer base by a sputtering deposition method.

4. The membrane as claimed in claim 1, wherein the metal layer is formed on the polymer base by an electroless plating method.

5. The membrane as claimed in claim 1, wherein the metal layer is formed on two opposite surfaces of the polymer base.

6. A method for making a membrane for fuel cells, the method comprising the steps of:
providing a polymer base;
forming a first metallic layer on the polymer base; and
forming a second metallic layer on the first metallic layer; wherein the first and second metallic layers are comprised of a material selected from the group consisting of nickel, palladium, platinum and gold.

7. The method as claimed in claim 6, wherein the polymer base is comprised of a material selected from the group consisting of polyethylene, polypropylene, polysulfone, polyimide, polyvinylidenefluoride, polyurethane, polystyrene, polyvinylchloride, cellulose, nylon, a copolymer of vinylidenefluoride and hexafluoropropylene, a copolymer of vinylidenefluoride and trifluoroethylene, a copolymer of vinylidenefluoride and tetrafluoroethylene, acrylate based polymer, polyacrylonitrile, polyvinylacetate, polyethyleneoxide, and polypropyleneoxide.

8. The method as claimed in claim 6, wherein the first metal layer is formed on the polymer matrix by a sputtering method.

9. The method as claimed in claim 6, wherein the second metal layer is formed on the first metal layer by an electroless plating method.

10. The method as claimed in claim 6, wherein the first and second metal layers are formed on two opposite surfaces of the polymer base.

11. A membrane-electrode assembly for fuel cells, the membrane electrode assembly comprising:
an anode;
a cathode; and
an membrane as claimed in claim 1.

12. The membrane-electrode assembly as claimed in claim 11, wherein the anode is electrically conductive and is comprised of a material selected from the group consisting of graphite, carbon composite and metal.

13. The membrane-electrode assembly as claimed in claim 11, wherein the cathode is electrically conductive and is comprised of a material selected from the group consisting of graphite, carbon composite and metal.

14. The membrane-electrode assembly as claimed in claim 11, wherein a catalyst material is coated on the anode and cathode; the catalyst material are selected from the group consisting of platinum, ruthenium and an alloy of platinum and ruthenium.
